(19) United States
(12) Patent Application Publication
(10) Pub. No.: US 2020/0407039 A1
(43) Pub. Date: Dec. 31, 2020

(54) WING-TO-BODY TRAILING EDGE FAIRING AND METHOD OF FABRICATING SAME

(71) Applicants: SANDERS LEE, Ft. Worth, TX (US); Eric A. AHLSTROM, South Willard, UT (US); Matthew David WILSON, South Odgen, UT (US); AERO DESIGN LABS, INC., Ft. Worth, TX (US)

(72) Inventors: Lee SANDERS, Ft. Worth, TX (US); Eric A. AHLSTROM, South Willard, UT (US); Mathew David WILSON, South Odgen, UT (US)

(21) Appl. No.: 16/978,940

(22) PCT Filed: Mar. 12, 2019
(86) PCT No.: PCT/US2019/021804

§ 371 Date: Sep. 8, 2020

Related U.S. Application Data
(63) Continuation of application No. 29/640,190, filed on Mar. 12, 2018.
(60) Provisional application No. 62/641,897, filed on Mar. 12, 2018.
(60) Provisional application No. 62/664,995, filed on May 1, 2018.

(51) Int. Cl. B64C 1/26; B64F 5/10; B64C 7/00; B64C 21/02

(52) U.S. Cl. CPC B64C 1/26; B64C 21/02; B64C 7/00; B64F 5/10

(57) ABSTRACT

A wing-to-body fairing on an aircraft having a fuselage, wing, and a wing root fairing. The wing-to-body fairing includes forward and trailing edges. The forward edge is configured for positioning adjacent a first predetermined location of an aft portion of the wing root fairing. The trailing edge is configured for positioning adjacent a second predetermined location of the aft portion of the fuselage. A convex-shaped forward portion of the fairing is configured to conform to the aft portion of the wing root fairing at the first predetermined location. A concave-shaped aft portion of the fairing is configured to conform to the aft portion of the fuselage at the second predetermined location. An exterior surface of the wing-to-body fairing is gradient optimized to minimize curvature, where the fairing trailing edge is configured with matching angles and contours as the aft portion of the fuselage at the second location.

### CROSS-REFERENCE TO RELATED APPLICATION

This patent application claims priority to U.S. provisional Application No. 62/664,995, filed May 1, 2018, U.S. provisional Application No. 62/641,897, filed Mar. 12, 2018, and U.S. Design application Ser. No. 29/640,190, filed Mar. 12, 2018, the contents of which are incorporated by reference herein in their entireties.

### FIELD OF INVENTION

The invention relates to aircraft fairings, and more specifically to a fairing mounted at a wing root trailing edge of an aircraft.

### BACKGROUND OF INVENTION

Commercial aircraft cabins are pressurized and, therefore, the fuselage is cylindrical in shape to accommodate the loads of pressurization with minimal structural weight. The wing structure and many accessory systems protrude outside the contour of the round fuselage and typically require fairings to maintain streamlined airflow around these systems which, by the nature of their mechanics and physical characteristics, are not necessarily cylindrical in shape.

The structural and accessory fairings typically cover environmental systems, auxiliary equipment outside the fuselage pressure vessel, the wing center structure, and the main landing gear generally located forward to aft of the mid fuselage area. The fairings are symmetrical on the left and right sides of the aircraft with the exception of various auxiliary system inlets, outlets, access panels, drain masts, antenna and the like which may not be positioned symmetrically on both sides of the aircraft. The majority of such auxiliary and accessory systems are located forward of the wing root (inboard) trailing edge. The main landing gear wheel wells are typically the widest of these systems and are normally located just forward of the wing trailing edge.

As a consequence, the aft portion of the wing root fairing is often designed primarily as a mechanical cover for these various systems, but is not optimized for aerodynamic efficiency. The fairings of the main landing gear wheel wells are typically a primary determinant of the fairing shape at the port and starboard wing root trailing edges.

Referring to FIGS. 21A, 22A and 23A, an airframe 100, such as BOEING™ airframe model 737 NG or 737 MAX airframe is illustratively shown. These model airframes are equipped on each side with a trailing edge wing root fairing 110 that creates separated airflow at the fairing's trailing edges 114 on the side and belly of the fuselage 101, aft of the fairing 110. As a result, significant drag and noise can be undesirably induced by the airflow separation as shown by Arrow “A” (FIG. 21A), which points to heavily concentrated flow lines illustrating turbulence where the trailing edge 114 of the current wing root fairing 110 intersects with the fuselage 102.

In particular, the forward edge of the wing root fairing 110, which is mounted at the trailing edge of the wing 104, is typically at the same angle as the wing root fairing surface at the trailing edge of the wing 104. Current design practice is to curve the aft portion 114 of the fairing 110 inwards so that it mates with the fuselage pressure vessel 102 at a steep angle (arrow “B” of FIG. 23A). It has been observed that the steep angle of the aft end 114 of the fairing 110 intersecting with the fuselage 102 can cause high-pressure, inboard vortices, which further increase drag and noise along the surface of the airframe 100. The design of the wing root fairing 110 is typical of most current generation, low-wing commercial airliners and has been accepted for many years by industry practice. One possible explanation for maintaining its present configuration is that the abrupt trailing edge fairing transition to the fuselage pressure vessel is smaller, lighter and more mechanically convenient than a longer optimized design would be. As well, wind tunnel testing on a full scale model airframe makes it very difficult to visualize the inboard wing vortex flow that current fairing design practice causes. Some aircraft designers have incorporated strakes, or wing trailing edge extensions, such as are present on the Airbus A380 and A350 model aircrafts. However, these alternative designs have not addressed either the steep or abrupt angle of the aft portion 114 of the fairing 110 at the location where it meets the aft portion of the fuselage pressure vessel 101, or the optimization of the wing root fairing contour for improved airflow.

During flight of the low-wing aircraft, this lack of foresight has led to the majority of current generation airliners to be subject to an inboard trailing edge vortex which begins at the end of the trailing edge wing root fairing 110. Such vortex is not present at lower Reynolds numbers encountered in most wind tunnels. The practice of a steep angle between the aft edge of the wing root fairing and the straight surface of the aft fuselage pressure vessel has been common and mostly unchanged in previous commercial aircraft design.

While computational fluid dynamics (CFD) has been used for many years, the relative power of CFD in practice has been limited by the number of cells analyzed. Because the area of the inboard wing root trailing edge vortex requires nearly as many cells to resolve the vortex as are used on the entire rest of the model, there has been little incentive in the industry to incur this cost in analysis, and has therefore been overlooked.

Resolving the inboard vortex in CFD requires defining an entire wing downwash sheet and its interactions with the vortex flow at the fuselage to orders of magnitude beyond common practice. In fact, the aircraft industry has been focused for decades on reducing CFD cell count and mesh density wherever possible. Resolution of a fairing and its complete effects requires significant direct labor on the part of an analysis team to define, analyze, and refine the results. This process is iterative and requires significant amounts (e.g., more than ten times) the labor and computational resources of a single point of normal cell meshing and analysis. Moreover, the industry has not been greatly incentivized to conduct detailed experimentation to identify improvements to reduce drag and noise at various areas of the aircraft, as such benefits have not historically been seen as worth the effort and costs.

In view of the aforementioned and other deficiencies in the prior art, it is desirable to provide a trailing edge, wing-to-body fairing that minimizes airflow separation and noise observed at the intersection where the aft end of the trailing edge, wing root fairing intersects with the fuselage of an aircraft.

### SUMMARY OF THE INVENTION

The above disadvantages and deficiencies in the prior art are avoided and/or solved by various embodiments of a wing-to-body fairing on an aircraft having a fuselage, wing, and a wing root fairing. The wing-to-body fairing includes forward and trailing edges. The forward edge is configured for positioning adjacent a first predetermined location of an aft portion of the wing root fairing. The trailing edge is configured for positioning adjacent a second predetermined location of the aft portion of the fuselage. A profile and angle of the forward edge is configured to conform to the aft portion of the wing root fairing at the first predetermined location. A profile and angle of the trailing edge is configured to conform to the aft portion of the fuselage at the second predetermined location. An exterior surface of the wing-to-body fairing is gradient optimized to minimize curvature, where the fairing trailing edge is configured with matching angles and contours as the aft portion of the fuselage at the second location.

In one embodiment, a method of fabricating a wing-to-body fairing for reducing drag on an aircraft which has a fuselage, a wing, and a wing root fairing, the wing-to-body fairing being configured with forward and trailing edges, the forward edge of the wing-to-body fairing being configured for positioning at an aft portion of the wing root fairing and the trailing edge being configured for positioning at an aft portion of the fuselage, the method comprises the steps of: selecting a first predetermined location on the aircraft corresponding to the aft portion of the wing root fairing; selecting a second predetermined location on the aircraft corresponding to the aft portion of the fuselage;

determining a profile and angle of the forward edge of the wing-to-body fairing to conform to and match the aft portion of the wing root fairing at the first predetermined location; determining a profile and angle of the trailing edge of the wing-to-body fairing to conform to and match the aft portion of the fuselage at the second predetermined location; performing gradient optimization to minimize curvature over an exterior surface of the wing-to-body fairing based on the determined profile and angles at the forward and trailing edges of the wing-to-body fairing, wherein said gradient optimization includes providing a convex shaped profile at a forward portion of the wing-to-body fairing and a concave shaped profile at a rearward portion of the wing-to-body fairing; and forming the wing-to-body fairing with an exterior surface having a smooth curvature as defined by the gradient optimization, wherein the trailing edge of the wing-to-body fairing is configured with matching angles and contours as the aft portion of the fuselage at the second predetermined location.

In one aspect, the step of forming the wing-to-body fairing comprises configuring the forward edge of the wing-to-body fairing with matching angles and contours as the aft portion of the wing root fairing at the first predetermined location. In another aspect, the step of performing gradient optimization comprises selecting a plurality of control lines from the forward profile to the aft profile, and performing one-dimensional gradient optimization on each of the plurality of control lines. In yet another aspect, the step of selecting a plurality of control lines comprises determining a start point and an end point of each control line by subdividing the forward or aft edge profiles by uniform linear spacing. In a further aspect, the step of selecting a plurality of control lines comprises determining a start point and an end point of each control line by subdividing the forward or aft edge profiles by uniform angular spacing. In still another aspect, the step of selecting of the plurality of control lines comprises approximating airflow streamlines generated by at least one of computational fluid dynamics, wind tunnel testing, and flight testing. In yet another aspect, the step of selecting a plurality of control lines further comprises iteratively repeating the approximation of airflow streamlines using streamline data from previous iterations to select the plurality of control lines. In still another aspect, an analytical technique is used to functionally describe the optimal profile of each of the control lines.

In one aspect, at least one of a numerical and graphical technique is used to select a number of control points along each control line, and minimizing local curvature according to the equation: [(dy2/dx2)−(dy1/dx1)]/[(dx2+dx1)/2] for each of the control points. In another aspect, the step of performing gradient optimization over an exterior surface of the wing-to-body fairing comprises performing a multi-dimensional gradient optimization with a weighed combination of longitudinal and circumferential curvatures. In yet another aspect, the step of determining the multi-dimensional optimization includes minimizing local curvature according to the equation:

$$k \frac{{\partial }^{2} y}{\partial {x}^{2}} + ( 1 - k ) \frac{{\partial }^{2} z}{\partial {x}^{2}} ,$$

where k is a numeric value in a range from 0 to 1. In a further aspect, the steps of selecting the first and second predetermined locations on the aircraft include identifying first and second fuselage stations of the aircraft. In still another aspect, the gradient optimization includes transitioning in a direction along a longitudinal axis of the of the wing-to-body fairing from the convex shaped profile at a forward portion of the wing-to-body fairing to the concave shaped profile at a rearward portion of the wing-to-body fairing. In another aspect, the gradient optimization includes transitioning in a direction along a longitudinal axis of the of the wing-to-body fairing from the concave shaped profile at a rearward portion of the wing-to-body fairing to the convex shaped profile at a forward portion of the wing-to-body fairing.

In another embodiment, a wing-to-body fairing for reducing drag on an aircraft having a fuselage, a wing, and a wing root fairing, the wing-to-body fairing comprises: a forward edge, a trailing edge, an upper edge and a lower edge, wherein the forward edge is configured for positioning adjacent a first predetermined location of an aft portion of the wing root fairing and the trailing edge is configured for positioning adjacent a second predetermined location of the aft portion of the fuselage, wherein a profile and angle of the forward edge of the wing-to-body fairing is configured to conform to and match the aft portion of the wing root fairing at the first predetermined location, and a profile and angle of the trailing edge of the wing-to-body fairing is configured to conform to and match the aft portion of the fuselage at the second predetermined location; and wherein an exterior surface of the wing-to-body fairing is gradient optimized to minimize curvature over the exterior surface, said exterior surface having a generally convex shaped profile at a forward portion of the wing-to-body fairing and a generally concave shaped profile at a rearward portion of the wing-to-body fairing such that the trailing edge of the wing-to-body fairing is configured with matching angles and contours as the aft portion of the fuselage at the second predetermined location.

In one aspect, the gradient optimization includes transitioning in a direction along a longitudinal axis of the of the wing-to-body fairing from a generally convex shaped profile at a forward portion of the wing-to-body fairing to a generally concave shaped profile at a rearward portion of the wing-to-body fairing. In another aspect, the gradient optimization includes transitioning in a direction along a longitudinal axis of the of the wing-to-body fairing from a generally concave shaped profile at a rearward portion of the wing-to-body fairing to a generally convex shaped profile at a forward portion of the wing-to-body fairing.

In one aspect, the forward edge of the wing-to-body fairing is configured with matching angles and contours as the aft portion of the wing root fairing at the first predetermined location. In another aspect, the exterior surface of the wing-to-body fairing is gradient optimized by one-dimensional gradient optimization on each of a plurality of control lines. In a further aspect, the plurality of control lines extend from the forward edge profile to the trailing edge profile and are subdivided by uniform linear spacing. In yet another aspect, the plurality of control lines extend from the forward edge profile to the trailing edge profile and are subdivided by uniform angular spacing. In still another aspect, the plurality of control lines are defined by data received from at least one of computational fluid dynamics, wind tunnel testing, and flight testing.

In another aspect, the exterior surface of the wing-to-body fairing is gradient optimized by at least one of a numerical and graphical technique to select a number of control points along each control line, and minimize local curvature according to the equation: [(dy2/dx2)−(dy1/dx1)]/[(dx2+dx1)/2] for each of the control points. In yet another aspect, the exterior surface of the wing-to-body fairing is gradient optimized by multi-dimensional gradient optimization with a weighed combination of longitudinal and circumferential curvatures. In another aspect, the multi-dimensional optimization includes minimizing local curvature according to the equation:

$$k \frac{{\partial }^{2} y}{\partial {x}^{2}} + ( 1 - k ) \frac{{\partial }^{2} z}{\partial {x}^{2}} ,$$

where k is a numeric value in a range from 0 to 1.

In one aspect, the first and second predetermined locations are defined by fuselage stations of the aircraft. In another aspect, the aircraft includes a baggage/cargo door positioned at an aft side portion of the fuselage, the baggage/cargo door being openable outwardly, and wherein an aft portion of the wing-to-body fairing is formed on an exterior surface of the baggage/cargo door. In a further aspect, the wing-to-body fairing is configured with a length that is in a range of 70% and 150% of a diameter of a cylindrical portion of the fuselage.

In one aspect, the aircraft includes a baggage/cargo door positioned at an aft side portion of the fuselage, the baggage/cargo door being openable outwardly, and wherein the trailing edge of the wing-to-body fairing is formed longitudinally ahead of a leading edge of the baggage/cargo door. In another aspect, the wing-to-body fairing is configured with a length that is in a range of 70% and 150% of a diameter of a cylindrical portion of the fuselage.

In one aspect, the aircraft includes a baggage/cargo door positioned at an aft side portion of the fuselage, the baggage/cargo door being openable inwardly, and wherein the trailing edge of the wing-to-body fairing is formed longitudinally ahead of a leading edge of the baggage/cargo door and without increasing an outer mold line of the baggage/cargo door. In another aspect, the wing-to-body fairing is configured with a length that is in a range of 70% and 150% of a diameter of a cylindrical portion of the fuselage.

In one aspect, the wing-to-body fairing is configured for installation on one of a BOEING model 737 NG-700, 737 NG-800, and 737 NG-900 aircraft to reduce drag and noise by reducing airflow separation aft of a wing to fuselage junction. In another aspect, the wing-to-body fairing is configured for installation on one of a BOEING model 737 MAX-7, 737 MAX-8, 737 MAX-9, and 737 MAX-10 aircraft to reduce drag and noise by reducing airflow separation aft of a wing to fuselage junction.

In yet another embodiment, a method of fabricating a wing-to-body fairing for reducing drag on an aircraft which has a fuselage, a wing, and a wing root fairing, the wing-to-body fairing being configured with forward and trailing edges, the forward edge of the wing-to-body fairing being configured for positioning at an aft portion of the wing root fairing and the trailing edge being configured for positioning at an aft portion of the fuselage, the method comprises the steps of: selecting a first predetermined location on the aircraft corresponding to the aft portion of the wing root fairing; selecting a second predetermined location on the aircraft corresponding to the aft portion of the fuselage; determining a profile and angle of the forward edge of the wing-to-body fairing to conform to and match the aft portion of the wing root fairing at the first predetermined location; determining a profile and angle of the trailing edge of the wing-to-body fairing to conform to and match the aft portion of the fuselage at the second predetermined location; performing gradient optimization to minimize curvature over an exterior surface of the wing-to-body fairing based on the determined profile and angles at the forward and trailing edges of the wing-to-body fairing; and forming the wing-to-body fairing with an exterior surface having a smooth curvature as defined by the gradient optimization, wherein the trailing edge of the wing-to-body fairing is configured with matching angles and contours as the aft portion of the fuselage at the second predetermined location.

In one aspect, the said gradient optimization includes transitioning in a direction along a longitudinal axis of the of the wing-to-body fairing from a convex shaped profile at a forward portion of the wing-to-body fairing to a concave shaped profile at a rearward portion of the wing-to-body fairing. In yet another aspect, the gradient optimization includes transitioning in a direction along a longitudinal axis of the of the wing-to-body fairing from a concave shaped profile at a rearward portion of the wing-to-body fairing to a convex shaped profile at a forward portion of the wing-to-body fairing.

In still another embodiment, a wing-to-body fairing for reducing drag on an aircraft having a fuselage, a wing, and a wing root fairing, the wing-to-body fairing comprises: a forward edge, a trailing edge, an upper edge and a lower edge, wherein the forward edge is configured for positioning adjacent a first predetermined location of an aft portion of the wing root fairing and the trailing edge is configured for positioning adjacent a second predetermined location of the aft portion of the fuselage, wherein a profile and angle of the forward edge of the wing-to-body fairing is configured to conform to and match the aft portion of the wing root fairing at the first predetermined location, and a profile and angle of the trailing edge of the wing-to-body fairing is configured to conform to and match the aft portion of the fuselage at the second predetermined location; and wherein an exterior surface of the wing-to-body fairing is gradient optimized to minimize curvature over the exterior surface, such that the trailing edge of the wing-to-body fairing is configured with matching angles and contours as the aft portion of the fuselage at the second predetermined location. In a further embodiment, a wing-to-body fairing for reducing drag on an aircraft including a fuselage having a cylindrical pressure vessel, a wing, a wing root fairing and main landing gear, the wing-to-body fairing comprises: a forward edge, a trailing edge, an upper edge and a lower edge, wherein the forward edge is configured for positioning adjacent a first predetermined location of an aft portion of the wing root fairing, the first predetermined location being determined by a cross section of the main landing gear, the trailing edge being configured for positioning adjacent a second predetermined location of the aft portion of the cylindrical pressure vessel, wherein a profile and angle of the forward edge of the wing-to-body fairing is configured to conform to and match the aft portion of the wing root fairing at the first predetermined location, and a profile and angle of the trailing edge of the wing-to-body fairing is configured to conform to and match the aft portion of the fuselage at the second predetermined location; and wherein an exterior surface of the wing-to-body fairing is gradient optimized to minimize curvature over the exterior surface, such that the trailing edge of the wing-to-body fairing is configured with matching angles and contours as the aft portion of the fuselage at the second predetermined location.

In one aspect, the forward edge is determined by a cross section of the aircraft faring located at the main landing gear and the trailing edge is determined by a cross section of the cylindrical portion of the pressure vessel. In another aspect, the multi-dimensional optimization includes minimizing local curvature according to the equation:

$$k \frac{{\partial }^{2} y}{\partial {x}^{2}} + ( 1 - k ) \frac{{\partial }^{2} z}{\partial {x}^{2}} ,$$

where K is a numeric value in a range from 0 to 1. In a further aspect, the wing-to-body fairing is configured with a length that is in a range of 70% and 150% of a diameter of a cylindrical portion of the fuselage.

### BRIEF DESCRIPTION OF THE DRAWINGS

FIGS. 1A and 1B are illustrations of rearward, bottom-quarter, right side perspective views of an exterior portion of an aircraft with and without a rear cargo door, respectively, with both aircraft illustratively depicting a wing-to-body trailing edge fairing mounted to the aircraft in accordance with the present invention;

FIG. 2 depicts a rear, right side perspective view of an aircraft having the trailing edge wing-to-body fairing of FIGS. 1A and 1B installed thereon;

FIG. 3 depicts an enlarged rear, right side perspective view of the trailing edge wing-to-body fairing of FIGS. 1A and 1B;

FIG. 4 depicts a rear elevational view of the aircraft of FIGS. 1A and 1B illustrating the starboard and port side trailing edge wing-to-body fairings installed thereon;

FIG. 5 depicts a right elevational view of the aircraft and having the trailing edge wing-to-body fairing of FIGS. 1A and 1B installed thereon;

FIG. 6 depicts a left elevational view of the aircraft and having the trailing edge wing-to-body fairing of FIGS. 1A and 1B installed thereon;

FIG. 7 depicts a bottom view of the aircraft illustrating the starboard and port side trailing edge wing-to-body fairings of FIGS. 1A and 1B installed thereon;

FIG. 8 is a flow diagram depicting a method for fabricating the wing-to-body fairing of the present invention.

FIG. 9 is an enlarged elevated view of the wing-to-body fairing and illustrating gradient optimized, outer mold line (OML) control lines extending in a longitudinal direction of the aircraft;

FIG. 10 depicts the rear, bottom right side perspective view of the starboard side trailing edge wing-to-body fairing of FIGS. 1A and 1B, the port side trailing edge wing-to-body fairing being a mirror image thereof;

FIG. 11 depicts the rear elevational view thereof;

FIG. 12 depicts the right elevation view of the starboard fairing thereof;

FIG. 13 depicts the front, right side perspective view thereof;

FIG. 14 depicts the front elevational view thereof;

FIG. 15 depicts the bottom view of the fairing thereof;

FIG. 16 depicts the low quarter, front right side perspective view thereof;

FIG. 17 depicts the low quarter, right elevational view thereof;

FIG. 18 depicts the low quarter, bottom, rear, right side perspective view thereof;

FIG. 19 depicts the low quarter, bottom, front, right side perspective view thereof;

FIGS. 20A and 20B are comparative graphical representations of a prior art wing-to-body fairing profile and a wing-to-body exterior surface profile using gradient optimization to minimize local curvature along the control lines of FIGS. 9-19, respectively;

FIG. 21A (prior art) and FIG. 21B are graphical images of the top, right side perspective views of an aircraft without and with the trailing edge wing-to-body fairing mounted at the wing root trailing edge of the aircraft, respectively, and comparatively displaying computer simulations of high and low velocity surface air flow and turbulence over the fuselage and wings of the aircraft with and without the wing-to-body fairings;

FIG. 22A (prior art) and FIG. 22B are graphical images of bottom, right side perspective views of the aircraft without and with the wing-to-body fairings mounted at the wing root trailing edge of the aircraft, respectively, and comparatively displaying computer simulations of high and low velocity surface air flow and turbulence over the fuselage and wings of the aircraft with and without the wing-to-body fairings;

FIG. 23A (prior art) and FIG. 23B are graphical images of bottom views of the aircraft without and with the wing-to-body fairings mounted at the wing root trailing edge of the aircraft, respectively, and comparatively displaying computer simulations of high and low velocity surface air flow and turbulence over the fuselage and wings of the aircraft with and without the wing-to-body fairings;

FIG. 24 is graphical representation illustrating a series of fuselage station profiles for a low-wing commercial aircraft; and

FIG. 25 depicts a rearward, bottom, right side perspective view of an aircraft having the right side trailing edge wing root fairing removed to expose the interior cabin walls and outer hull support ribs;

FIG. 26 depicts a forward, bottom, right side perspective view of the aircraft of FIG. 25 having the right side trailing edge wing root fairing removed to expose the interior cabin walls and outer hull support ribs; and

FIG. 27 depicts a right side elevational view of the aircraft of FIG. 25 having a right side trailing edge wing-to-body fairing of the present invention mounted thereon adjacent a rear cargo door.

To further facilitate an understanding of the invention, the same reference numerals have been used, when appropriate, to designate the same or similar elements that are common to the figures. Further, unless otherwise indicated, the features shown in the figures are not drawn to scale, but are shown for illustrative purposes only.

### DETAILED DESCRIPTION OF THE EMBODIMENTS

The present invention is directed to a trailing edge wing-to-body (WTB) fairing which is positioned at an aft end of the wing root fairing on both right and left sides of an aircraft. The trailing edge wing-to-body fairing is configured and contoured in such a manner so as to smooth out and eliminate abrupt or sharp angles at the location where the trailing edge of the wing-to-body fairing is joined with the exterior surface of the fuselage, thereby minimizing separation of airflow. More specifically, the trailing edge wing-to-body fairing of the present invention is gradient optimized along its exterior surface from its forward (i.e., leading) edge (which mates with the trailing edge of the wing root fairing) to its aft trailing edge, which is contoured to be parallel or substantially parallel (i.e., tangential) to the contour of the fuselage where the aft end portion of the WTB fairing mates thereto. The trailing edge wing-to-body fairing of the present invention reduces the airflow separation, drag and noise commonly observed at the trailing edge wing root fairing of current low-wing aircraft.

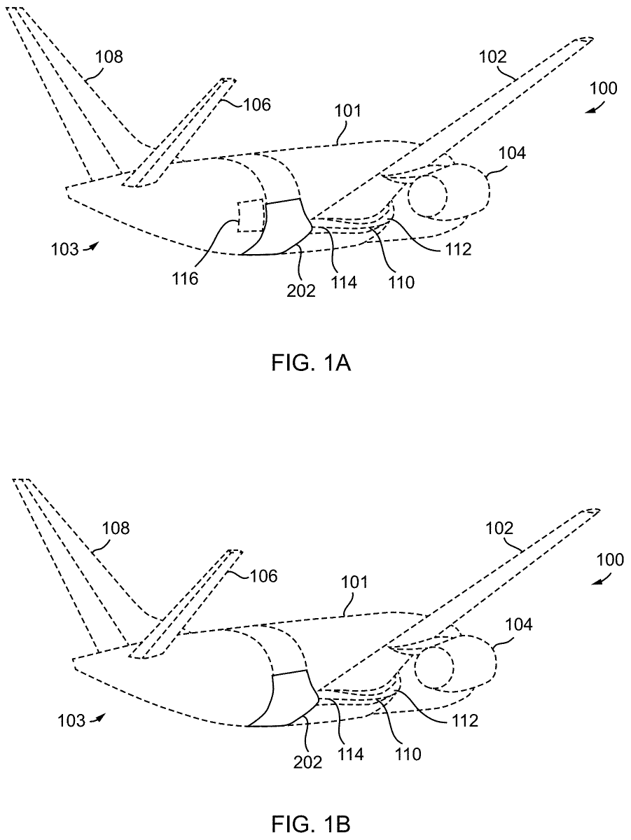

Referring to FIGS. 1A and 1B, a low-wing aircraft 100 is illustratively shown in each figure having a fuselage 101, a pair of wings (only the right wing shown) 102, engines 104, a pair of horizontal stabilizers (only the right horizontal stabilizer shown) 106, a vertical stabilizer or rudder 108, and a pair of wing root fairings (only a right wing root fairing shown) 110. Each wing root fairing 110 is formed about (e.g., above, beneath, forward and aft) each wing 102 and includes a forward edge portion 112 and a trailing edge or aft portion 114, as is well-known in the art. FIG. 1A illustratively shows an optional baggage/cargo compartment door or hatch 116 which is illustratively located in the aft portion 103 of the fuselage pressure vessel 101, which is the pressurized portions of the aircraft between the forward nose cone and the closure bulkhead at the aft end of the aircraft, as is well-known in the art.

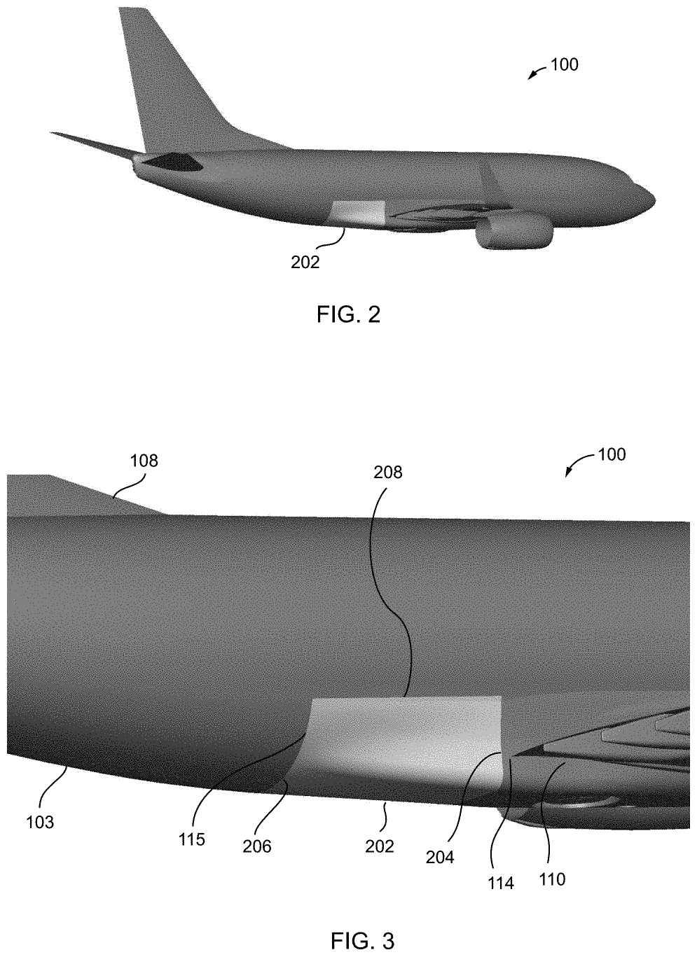

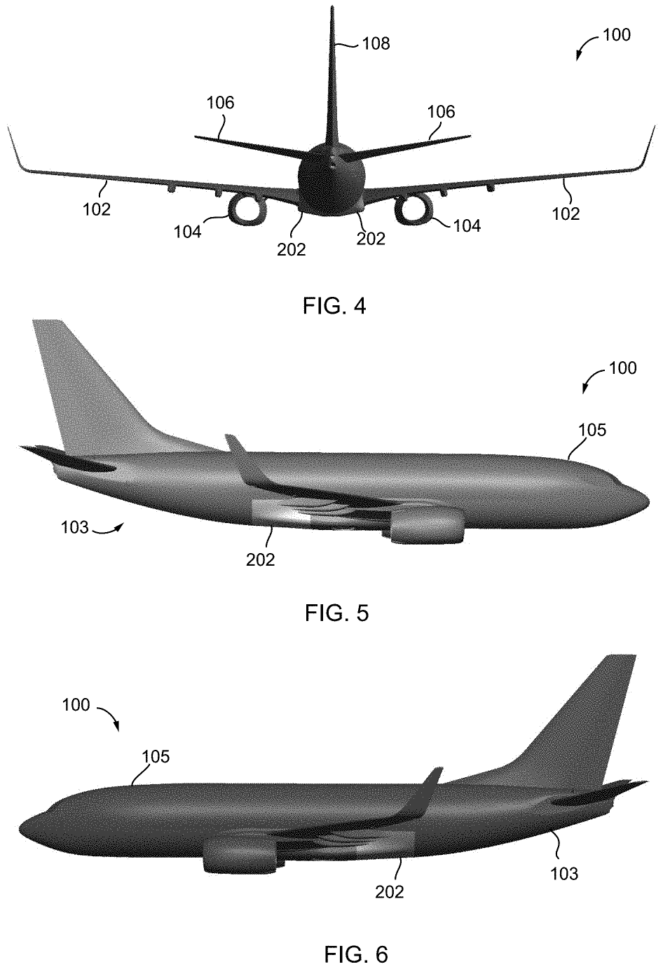

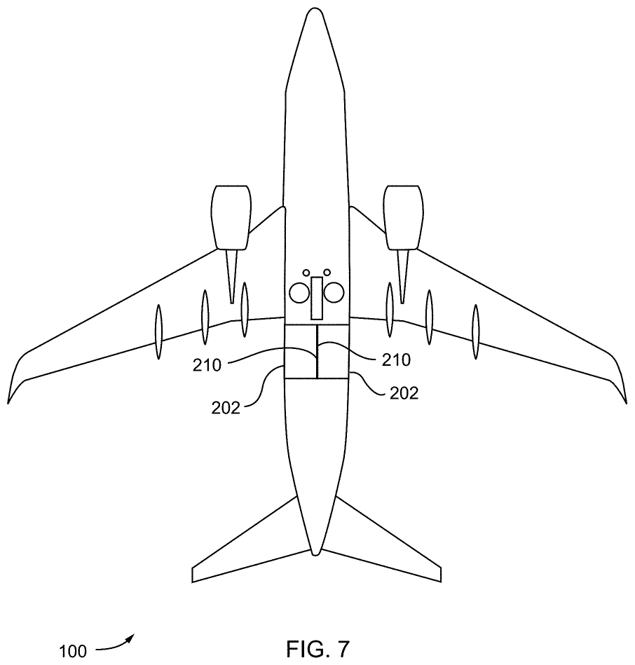

FIGS. 2-7 depict various views of the trailing edge wing-to-body fairing 202 installed on the right and left sides of the aircraft 100. Referring to an exploded view shown in FIG. 3, the leading edge 204 of the fairing 202 is configured to match the shape and angles of an aft portion 114 of the wing root 110. Similarly, the trailing edge 206 of the fairing 202 is configured to match the contour and angles of the respective adjacent aft portion 115 of the fuselage 101. As well, the upper edge 208 and lower edge 206 (FIG. 7) of the fairing 202 are gradient optimized to match the shape and angles of the adjacent portions of the fuselage 101 above and below the fairing 202.

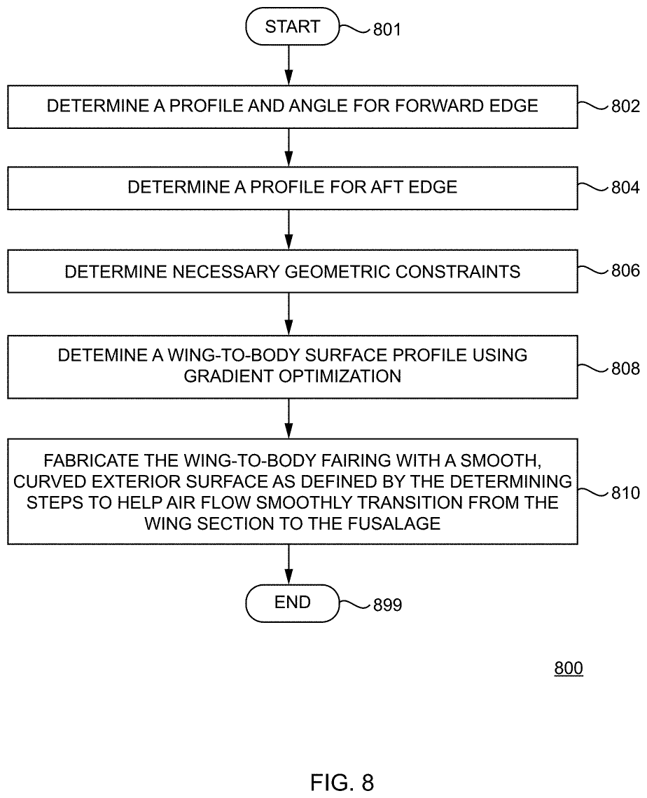

FIG. 8 is a flow diagram of a method 800 for fabricating the trailing edge wing-to-body fairing 200 of the present invention. The method 800 starts at step 801, where the locations at which the right and left fairings 202 are to be mounted on the right and left sides of the aircraft 100 are identified.

At step 802, the profile and angle of the forward edge of the right and left wing-to-body fairings 202 are determined. The forward edge 204 of each side fairing 202 is defined by a first predetermined location along the aft portion of the existing aircraft wing root fairing 110 and a cross-section of the main landing gear wheel wells. The forward edge 204 of the wing-to-body fairing 202 is configured to be at the same angle as the wing root fairing 110 forward of the first predetermined location.

At step 804, the profile and angle of the aft edge of the right and left wing-to-body fairings 202 are determined. The trailing edge 206 of the fairing 202 is defined by the curvature (e.g., round shape) of the aft portion of the fuselage pressure vessel 101 at a second predetermined location. Accordingly, the trailing edge 206 of the fairing 202 is configured with the same contour and at the same angle, i.e., parallel with and seamlessly connected to the adjacent surface of the pressure vessel fuselage 101. The profile of the right and left WTB fairings 202 are symmetrical on the right and left sides of the aircraft with the exception of various auxiliary system inlets, outlets, access panels, drain masts, antenna and the like, which may not be positioned symmetrically on both sides of the aircraft.

The first and second predetermined locations of steps 802 and 804 for a wing-to-body fairing 202 on a low-wing aircraft (e.g., 737 NG-700, 737 MAX-7, among other low-wing airframe models) can be defined by an aircraft location labeling (i.e., numbering) system, such as fuselage station (FS), butt line (BL) and water line (WL) reference designations of an existing airframe, which are cataloged in various documents and depicted in corresponding drawings for each model aircraft of an aircraft manufacturer in a well-known manner. In the United States, aircraft manufacturers designate the FS, BL and WL numbering systems to represent a distance in inches from a predetermined zero point, commonly known as the “reference datum” along an axis of the fuselage 101 (e.g., the longitudinal axis for FS designations) in a well-known manner. With respect to the fuselage stations, an imaginary vertical plane that is normal to the longitudinal axis of the aircraft is typically set at or near the nose or tip of the aircraft (i.e., the reference datum) from which all forward and aft distances can be measured. The flight station reference datum or zero point is generally designated as “FS 0”.

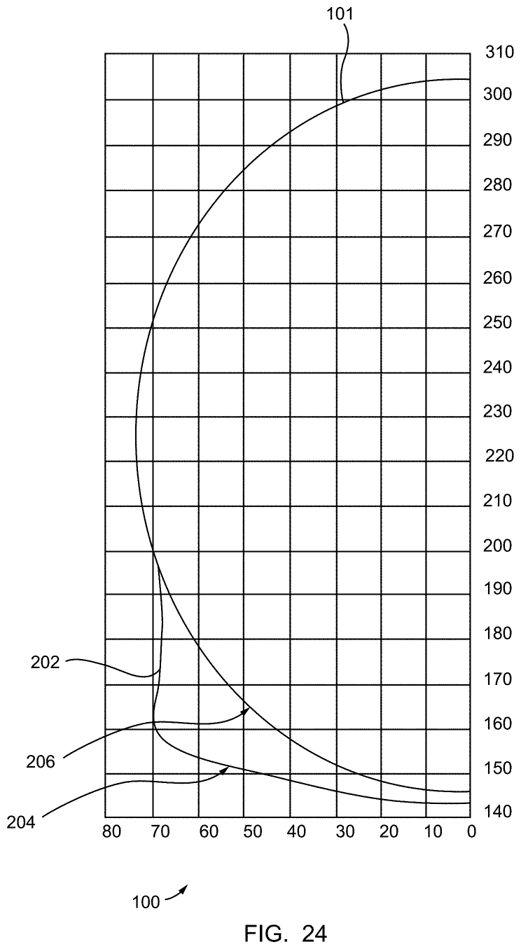

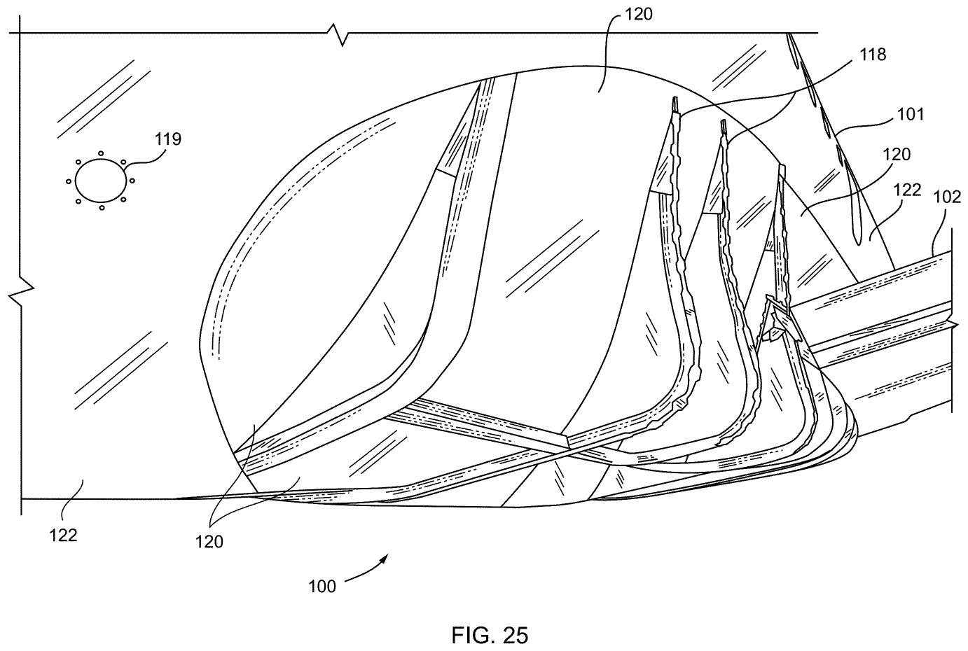

Referring now to FIG. 24, a computer graphic illustratively shows a cross-sectional view of a left side of an airframe fuselage 101 with the WTB fairing 202 of the present invention mounted thereon. The graphic shows both the leading edge 204 and trailing edge 206 fuselage stations superimposed on the fuselage 101 and WTB fairing 202. Because the FS are defined in inches, the fuselage station designations at the leading and trailing edges can be used calculate the length of the WTB fairing 202. For example, if at step 802 it is determined that the leading edge 204 of the WTB fairing 202 has a first predetermined location at FS 652, and at step 804 it is determined that the trailing edge 206 has a second predetermined location at FS 743, then the length of the WTB fairing is ninety-one inches (763-652). The gradient optimized, trailing edge WTB fairing 202 for commercial airliners for mounting aft of the trailing edge 114 of the wing 102 can optimally extend in length in a range of 70% to 150% of the nominal cylindrical diameter of the fuselage 101, depending on the positioning and type of aft baggage/cargo compartment door 116 that is present, as discussed below in further detail with respect to FIGS. 25-27. Although the length of the WTB fairing is discussed as preferably being within the range of 70% to 150% of the nominal cylindrical diameter of the fuselage, a person of ordinary skill in the art will appreciate that such range in the length of the WTB fairing is not considered limiting. For example, a longer fairing length would be required where the cross-section of the wheel wells extends further outboard and/or downward from the sides of the fuselage 101, as compared to airframes with a narrower fuselage cross-section at the wheel wells. Once the leading and trailing edges of the WTB fairing 202 are determined, the method 800 then proceeds to step 806.

At step 806, the necessary geometric constraints are determined. In particular, the upper edge 208 and lower edge 210 of the fairing 202, which define a width of the fairing 202 on each side of the airframe 100 is determined by the width of the existing wing root faring 110 at the first predetermined location, (i.e., aft of the wing 102) and extends inboard to the centerline of the fuselage 101. The width and positioning of the WTB fairing 202 can also be determined using the BL and WL reference designations in a similar manner as discussed above for determining the length of the fairing 202 with the assistance of fuselage station references. In addition, any structural/geometric constraints or restrictions that must be accounted and/or compensated for, such as limitations from the various auxiliary system inlets, outlets, access panels, drain masts, antenna and the like which are present beneath and/or extend through the fairing 202 are identified.

At step 808, the outer mold line transition from the forward edge 204 to the aft edge 206 is gradient optimized by minimizing the curvature of the surface primarily in the longitudinal direction, subject to any necessary geometric constraints. These constrains can include any combinations of minimum or maximum contained volume, maximum absolute curvature or angle of the fairing surface, clearance around existing components, maximum allowable fairing weight, desired cross-sectional area ruling, or manufacturability constraints. The exterior surface of the fairing 202 can be defined by either gradient optimization of a series of control lines, or by a multi-dimensional optimization of the full surface.

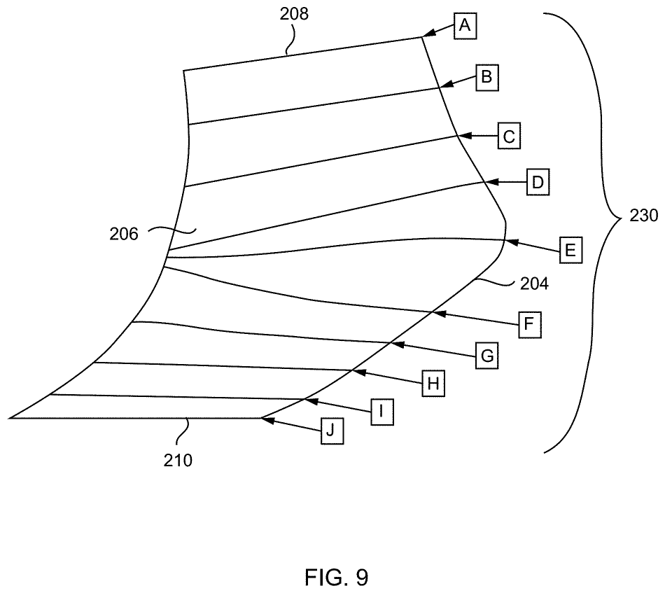

Referring to FIG. 9, the exterior surface 203 of the fairing 202 can be defined by a series of longitudinal control lines 230 that are individually gradient optimized. FIG. 9 illustratively shows control lines “A” through “J”, where control lines A and J represent the upper and lower edges 208, 210 of the fairing 202. Although eight control lines “B” through “I” are shown, such quantity is not considered limiting, as a person of ordinary skill in the art will appreciate that a greater number or lesser quantity of control lines 230 can be assigned to best define the shape, i.e., curvature and contour of the fairing 202. The start and end points of the control lines 230 are spaced on the forward and aft edges 204, 206 by equal linear spacing, equal angular spacing, or by aligning with local streamlines found by computational fluid dynamics, wind tunnel testing, flight testing, or any combination of these methods. The profile of each control line 230 is chosen to minimize the curvature over the length of the fairing either analytically or numerically.

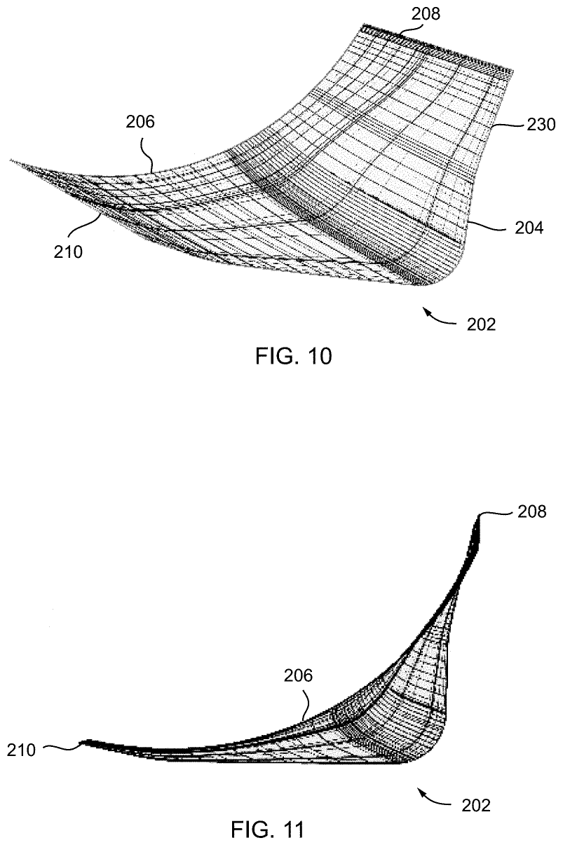

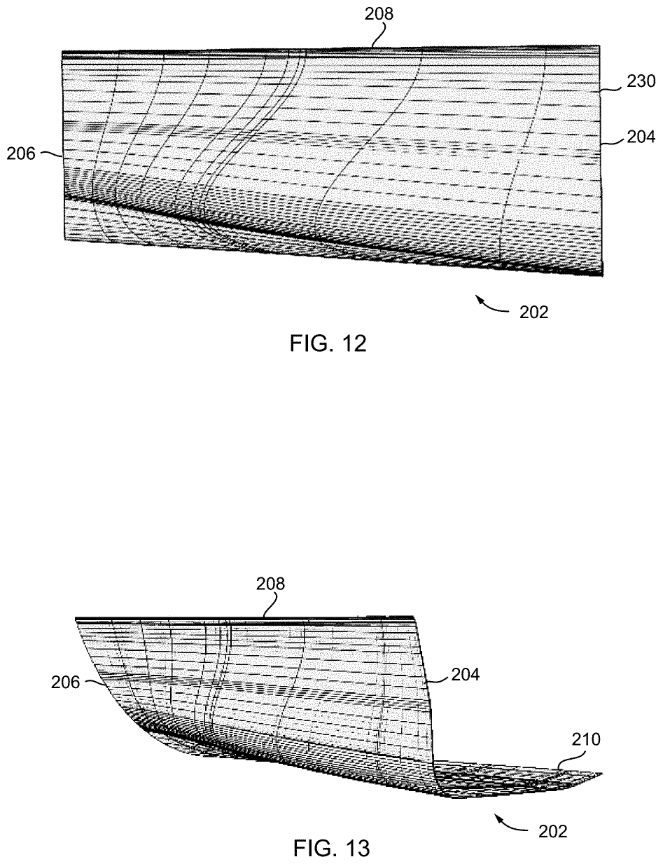

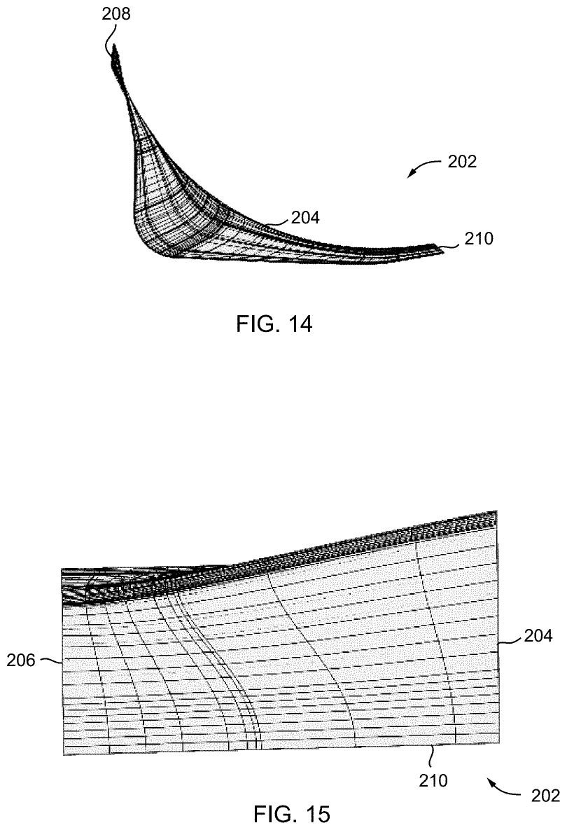

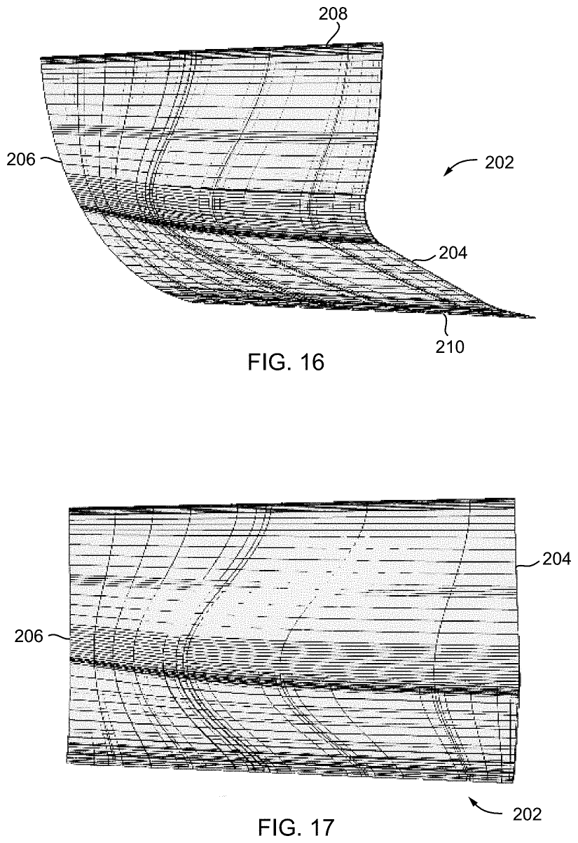

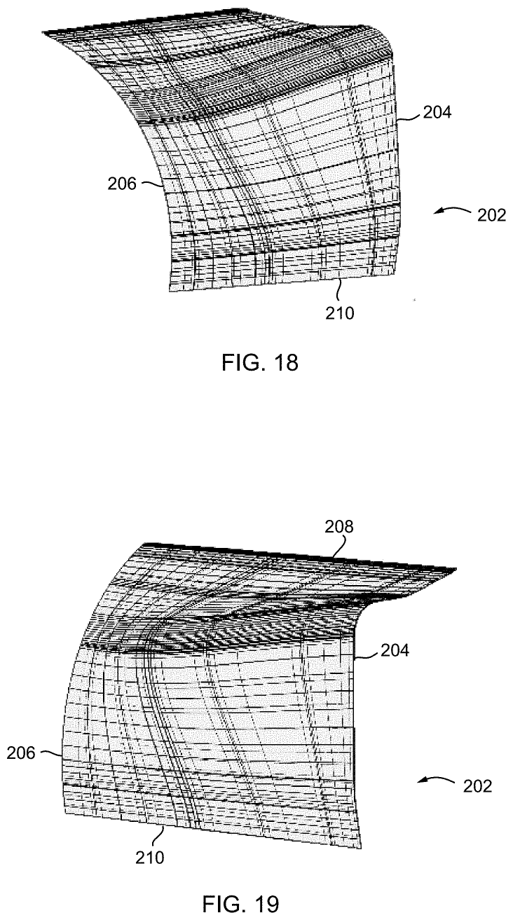

Referring now to FIGS. 10-19, various computer generated graphical images of the trailing edge wing-to-body fairing 202 are shown. The graphical images are illustratively configured for BOEING 737 NG and 737 MAX commercial model airframes; however a person of ordinary skill in the art will appreciate that the gradient optimized fairing of the present invention can be configured for other types and models of low-wing airframes. The trailing edge wing-to-body fairing 202 illustratively depicts a plurality of longitudinal and vertical control lines 230 in accordance with step 808 of the method 800 of FIG. 8.

In one embodiment, one or more control lines 230 are analytically optimized by selecting a function:

y=ƒ(x) Equation 1:

which has sufficiently minimal curvature from the start point xₘᵢₙ to the end point xₘₐₓ, while still matching the forward edge and its angle, the aft edge and its angle, and satisfying the desired geometric constraints. A person of ordinary skill in the art will appreciate that a variety of techniques exist to select parameters for a given function that satisfy the constraints while minimizing the curvature, as well as variational calculus techniques for finding a globally optimum function.

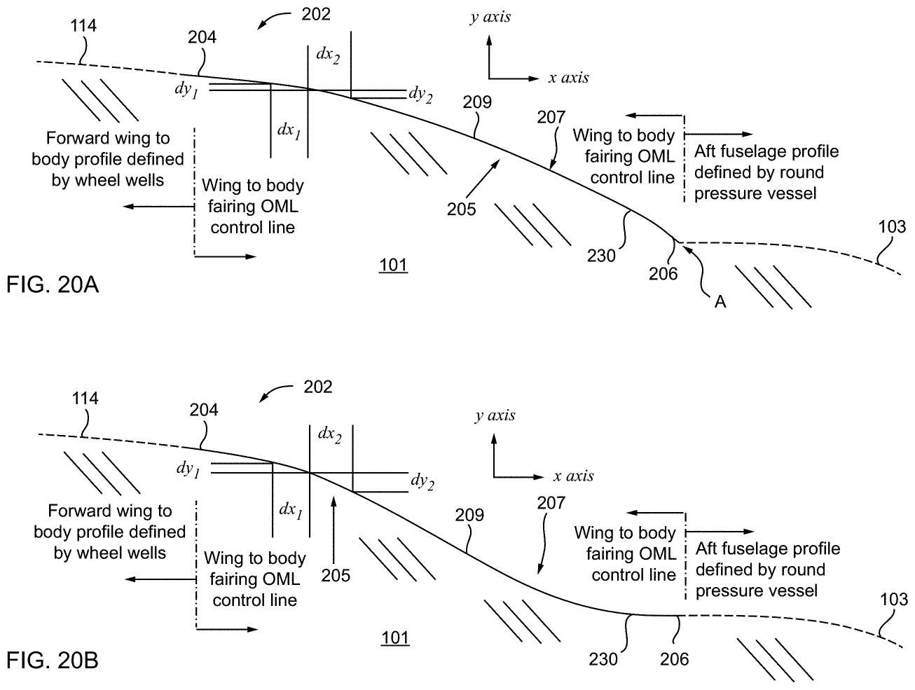

Referring to FIGS. 9 and 20, a control line 230 can be numerically or graphically optimized by selecting a number of points between xₘᵢₙ and xₘₐₓ (leading/trailing edges), and iteratively selecting “y” coordinates for each point that sufficiently minimize the exterior surface 203 of the fairing 202, in accordance with the equation:

[(dy₂/dx₂)−(dy₁/dx₁)]/[(dx₂+dx₁)/2] Equation 2:

for every point on each of the longitudinal control lines 230.

Referring to FIG. 20B, “x” and “y” are coordinates of a point on the control line and dy₁/dx₁ is a change in slope at a first location along the control line 230 and dy₂/dx₂ is a change in slope at a second location on the control line 230. Preferably, the profile of the fairing 202 in FIG. 20B has a convex-shaped forward portion and a concave-shaped aft portion with respect to the lateral side of the fuselage 101. In particular, the fairing 202 has a convex shape 205 from the trailing edge 114 of the wing 102 (i.e., the leading edge 204 of the fairing 202), and extends rearwardly at which the curvature of the fairing 202 changes or transitions to a concave shape 207 in which the trailing edge 206 of the fairing 202 conforms to and is parallel or substantially parallel to the contour of the fuselage where the aft end portion of the WTB fairing mates thereto. The transition 209 between the forward convex shaped curvature and the aft concave shaped curvature is the same tangential point between the convex and concave curves. By comparison and referring to FIG. 20A, the profile of the prior art wing-to-body fairing 111 maintains its convex shape from the trailing edge 114 to the point where the trailing edge 113 of the fairing 111 meets the aft portion 103 of the fuselage 101 at a sharp or abrupt angle, as discussed above.

Alternatively, a multi-dimensional optimization of the full exterior surface 203 can be performed. The exterior surface 203 may be defined by specifying the upper edge 208 and lower edge 210 fairing boundaries in addition to the forward and aft edges 204, 206, and similarly analytically or numerically minimizing a weighted curvature of the longitudinal and circumferential curvature, for example, by the formula set for the below in:

$$k \frac{{\partial }^{2} y}{\partial {x}^{2}} + ( 1 - k ) \frac{{\partial }^{2} z}{\partial {x}^{2}} , \qquad Equation 3$$

where x, y and z are coordinates of a point on the exterior surface and k is a numeric value in a range from 0 to 1.

Lofting a surface between the leading and trailing edges 204, 206 at the predetermined fuselage stations can be performed by any well-known computer aided design (CAD) software (e.g., SOLIDWORKS by Dassault Systems™ located in France). The three-dimensional CAD software program uses the predetermined boundary locations (e.g., steps 802 to 806), geometric surface constraints (e.g., step 806) and/or previously determined guide curves as inputs to calculate a surface that is gradient optimized for minimum change of curvature that satisfies a WTB fairing 202 for a particular model aircraft 100. A person of ordinary skill in the art will appreciate that any commercially available computer aided design software can be used to gradient optimize the WTB fairing profiles from the predetermined dimensions and level of definition.

The aerodynamic benefits of a gradient optimized fairing are most pronounced in relatively short fairings, where the configuration of the current wing root fairings 110 produce sharp fairing transitions to the pressure vessel 101. The longer trailing edge WTB fairing 202 is practical for installation on low-wing aircraft such as the Boeing 737-800, -900, 737-8, -9, and -10 commercial model airframes, where the aft baggage/cargo door 116 is positioned further aft along the fuselage 101 than the aft-most portion of the fairing 202.

Referring again to FIG. 8, at step 810 the wing-to-body fairing 202 is fabricated with a smooth, curved exterior surface, as determined by steps 802-808 discussed above, to help air flow smoothly transition from the wing section 102 to the fuselage 101 of the aircraft. The fairing 202 can be fabricated from well-known materials such as fiberglass, carbon fiber, Kevlar, Vectran or other aerospace grade reinforcing fibers and plastics. The fairing assembly 202 can also be fabricated from metals such as aluminum, steel, stainless steel, titanium, or other aerospace grade metals, or a combination of composite and metal materials. Processes for fabricating the fairing assembly 202 can include molding, machining, additive manufacturing, or combination of these practices. Once the fabrication process of the fairing assembly is completed, the fairing assembly 202 can be attached as a kit to older aircraft, or incorporated in to the fuselage a part of a new aircraft design. The method 800 then proceeds to step 899, where the method 800 ends.

Additional considerations for determining the shape, and especially the length and gradient optimization of the WTB fairing 202 include accounting for the type and positioning of baggage/cargo door 116 located at the aft portion 103 of the fuselage 101, if present. In particular, a typical low-wing commercial carrier includes an aft baggage/cargo door 116 located on one or both sides of the aircraft which can open either inwardly or outwardly. For example, the aft side baggage/cargo compartment doors 116 of the Boeing 737 family of aircraft open inwardly and loading and unloading of baggage is therefore limited by the outer mold line (OML) of the baggage door 116. For airframes where the baggage/cargo door 116 is positioned sufficiently aft along the fuselage 101 so as not to encroach or overlap where the aft portion of the WTB fairing 202 is to be positioned, the length of the fairing 202 can be extended or maximized rearwardly in a direction along the aircraft longitudinal axis from the wing root trailing edge 114 to thereby enable the gradient optimization process to minimize the overall changes in slope and/or contour/curvature of the fairing 202. Performing the gradient optimization step 808 over the length of the WTB fairing 202, and especially towards its trailing edge 206 helps to eliminate or minimize any abrupt angles at the trailing edge 206 of the WTB fairing 202, and thereby reduce air separation at the fuselage 101 and the undesirable drag and noise byproducts therefrom.

Alternatively, where the baggage/cargo door 116 is not positioned sufficiently aft along the fuselage 101 such that it could overlap and/or interfere with a fully gradient optimized fairing at its full length, the length of the WTB fairing 202 could require shortening. A reduction in the length of the WTB fairing 202 is generally dependent on the whether the baggage/cargo door 116 opens outwardly or inwardly. For airframes with outwardly openable baggage/cargo doors 116, the doors 116 will not cause an adjustment in the length of the WTB fairing 202, since the outer skin of the door can be shaped and dimensioned to the match the shape of the WTB fairing 202 if the door 116 were not present. In particular, where the aft baggage/cargo door 116 is openable outwardly, the OML of the baggage/cargo door 116 will not be increased by altering the exterior surface of the door 116 so that it conforms to, i.e., matches or takes on the shape and contours of the aft portion of the WTB fairing that intersects and overlies the baggage/cargo door 116. Conversely, where the baggage/cargo doors 116 open inwardly, mounting a section of the fairing 202 over the exterior surface of the baggage/cargo doors 116 would increase the OML of the doors 116. Increasing the OML of the baggage/cargo door 116 would require a significant structural change to the aircraft, as well as undesirably reduce the ability to load cargo into and out of the aircraft through the doors 116. Accordingly, the length of the trailing edge WTB fairing 202 is configured in a manner so that it will not interfere with the OML of the baggage/cargo door 116.

FIGS. 25-27 illustrate an airframe 100 having an inwardly openable baggage/cargo door 116 located at the aft portion 103 of the fuselage 101 of, for example, the Boeing 737 family of aircraft. For aircraft that include an aft baggage/cargo door(s) 116 that open inwardly, ingress and egress, i.e., loading and unloading of baggage is limited by the outer mold line (OML) of the baggage door 116. Accordingly, the structural and operational considerations for baggage/cargo loading and unloading generally preclude any modification to the OML of the aft baggage door 116.

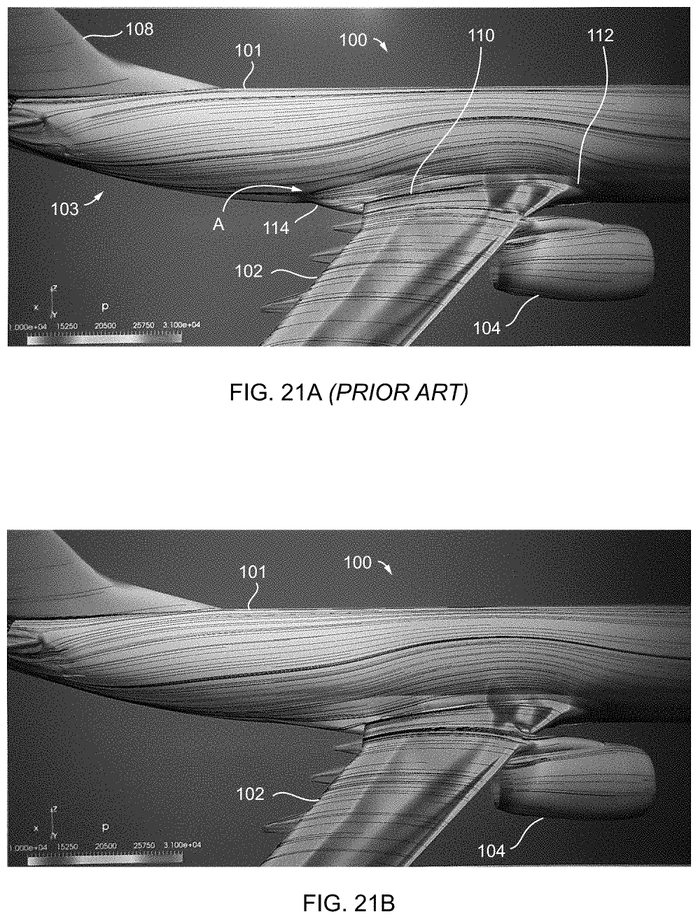

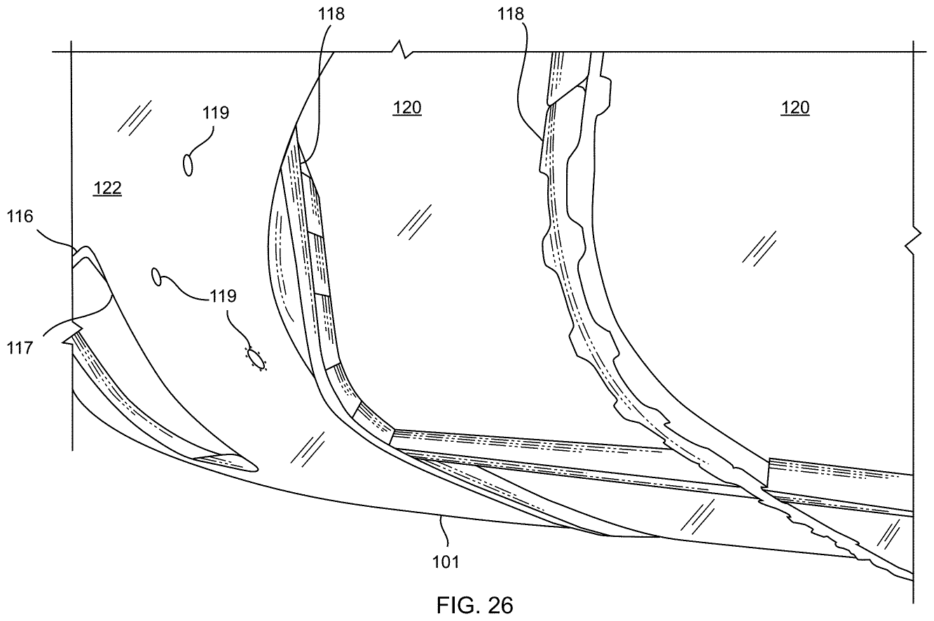

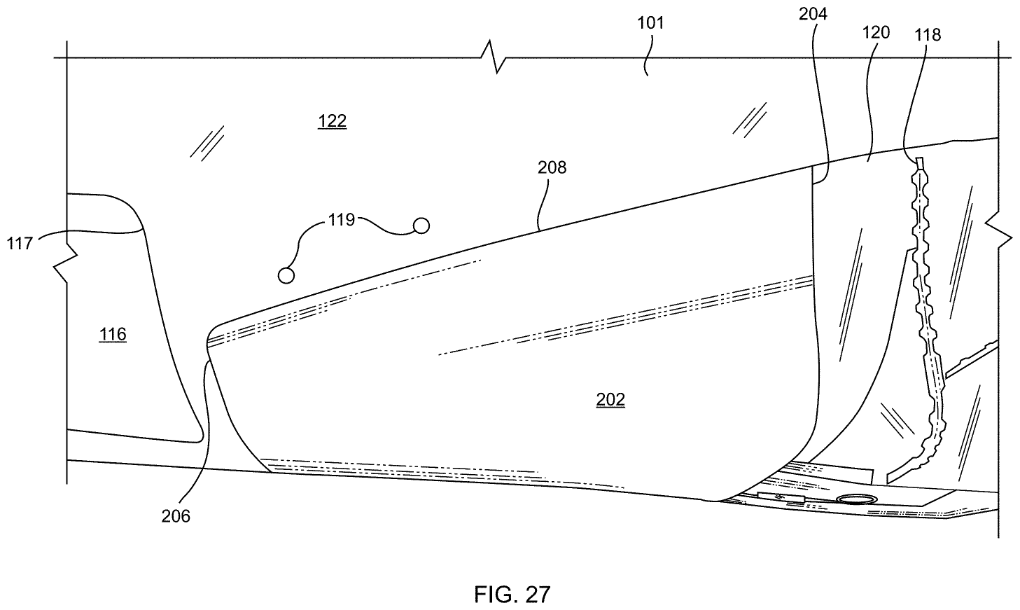

In FIGS. 25 and 26, a right lower side of an aircraft 100 is shown without the wing-to-body fairing of the present invention. The outer panels or hull skin 122 forming the aft portion 114 of the wing root fairing 110 is illustratively removed rearward of the wing 102, to thereby expose the inner cabin hull surface 120 and exterior vertical supports 118, which are provided to support and mount the wing root fairing 110 on the outer hull 122. In FIG. 26, the right side aft cargo door 116 and numerous intake/outlet ports 119 are shown. The trailing edge 114 of the wing root fairing 110 is illustratively spaced approximately sixty-seven inches from the leading edge 117 of the aft baggage/cargo door 116. By contrast, referring to FIG. 27, the wing-to-body fairing 202 of the present invention is shown installed on the same airframe 100 as shown in FIGS. 25 and 26. The fairing 202 is gradient optimized according to method 800, and is shown illustratively extending rearwardly along the longitudinal axis of the airframe 100 such that the trailing edge 206 terminates approximately seven inches from the leading edge 117 of the inwardly openable aft baggage/cargo door 116. It is to be understood that the dimensions described herein are for illustrative purposes only and are not considered as being limiting. In this embodiment with an inwardly openable cargo door 116, the WTB fairing 202 of the present invention allows for this critical structural consideration, and is therefore located forward of the leading edge 117 of the baggage/cargo door 116 so that no portion of the fairing 202 would increase the OML of the door and restrict baggage compartment access. Although the WTB fairing 202 has a reduced length along the longitudinal axis, the gradient optimization process of step 808 will generate a fairing exterior surface that has somewhat a greater change in overall slope than an embodiment having a longer length, but the abrupt angles observed at the trailing edge 114 of the wing root 110 have been eliminated. Therefore, air separation where the trailing edge 206 of the fairing 202 and the aft portion of the fuselage 101 meet is greatly minimized so that the undesirable drag and noise byproducts are also greatly reduced. A comparison with respect to air separation on an aircraft with and without the trailing edge wing-to-body fairing 202 installed on an aircraft 100 can best be seen in the graphic images of FIGS. 21A-23B.

Referring now to FIGS. 21A-23B, representations of various views of screen shots of computer-simulated aircraft to illustrate comparative effects on airflow with and without the wing-to-body fairing 202 of the present invention mounted on the aircraft 100 are illustratively shown. FIGS. 21A, 22A and 23A are right side views of an unmodified airframe 100 without the wing-to-body fairing 202 of the present invention. FIGS. 21B, 22B and 23B are right side views of the same airframe 100 being modified with the wing-to-body fairing 202 mounted on an aft portion of the fuselage 101 at the trailing edge 114 of the wing 102. The drawings were taken from color-coded computer simulations which were configured and performed by the inventors using the well-known NASA “Common Resource Model” (CRM) from the 5th AIAA Drag Prediction Workshop, although such simulation program is not considered limiting. The simulations conducted were from an industry standard model of a 767/777/A330/A350 class aircraft. The CRM is used throughout the industry in wind tunnel and computational fluid dynamics (CFD) work to develop an understanding of drag and how to predict it. High surface pressure areas are illustrated by darker shading, as compared to low surface pressure areas which are illustrated by lighter shading at specific areas of the aircraft.

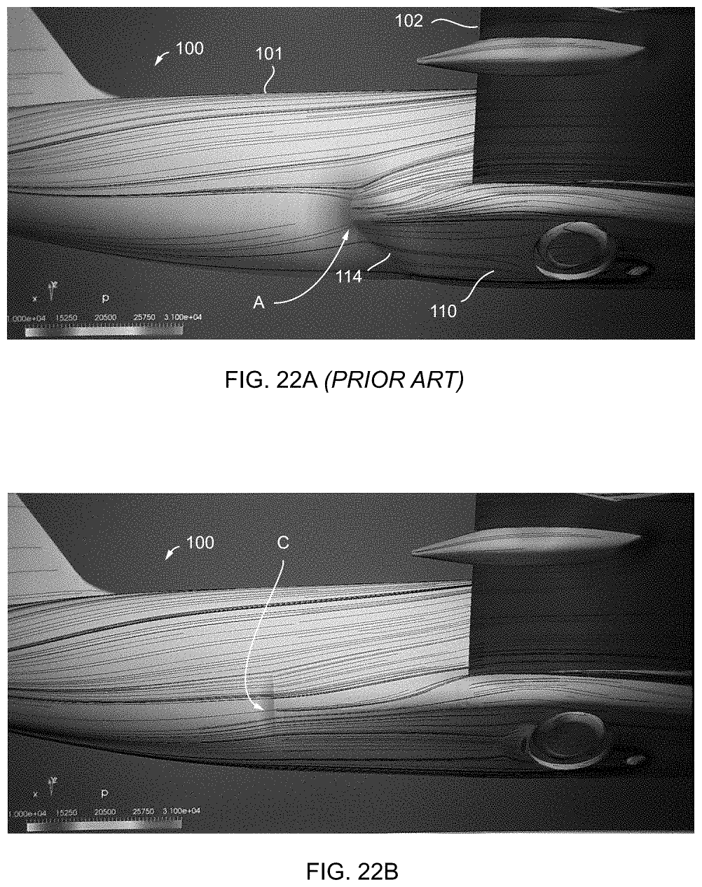

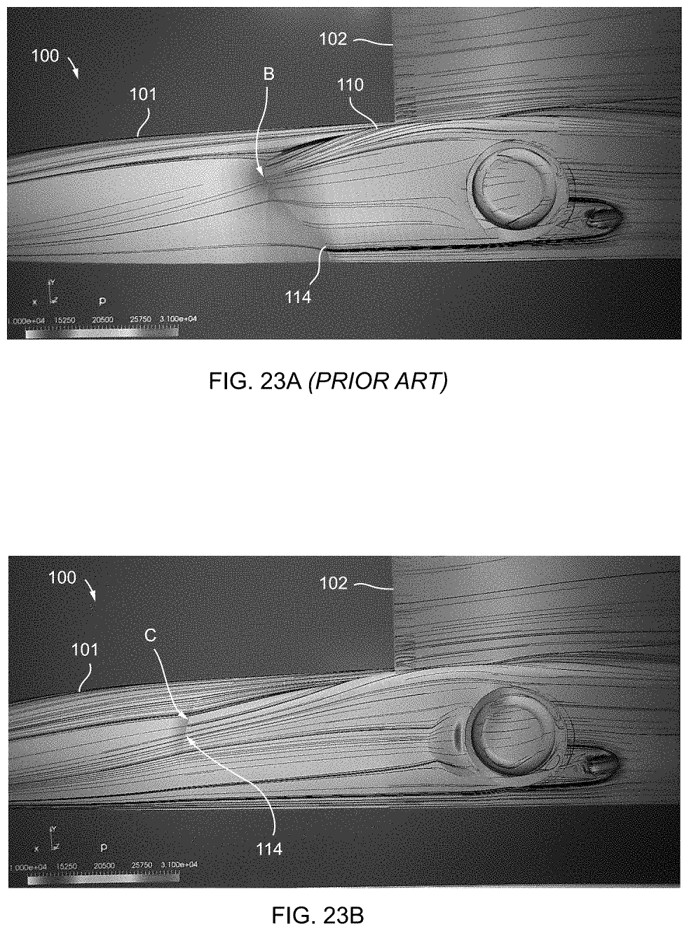

Referring to FIGS. 21A, 22A and 23A, the steep slope or abrupt angle formed at the trailing edge 114 of the wing root fairing 110 induces air separation that can cause downstream vortices, all of which induce significant drag and noise, as illustrated by arrows “A” and “B”, which indicate high pressure areas in FIGS. 22A and 23A. By contrast, with the wing-to-body fairing 202 mounted on the aircraft 100 aft of the wing 202 as discussed above, air separation, and thus drag and noise are greatly reduced, as best shown by arrow “C” indicating low pressure areas in FIGS. 22B and 23B. The reduction in air separation along the trailing edge wing-to-body fairing 202 and the fuselage 101 can be best seen in FIGS. 21B, 22B and 23B. Thus, FIGS. 21A-23B comparatively illustrate that the gradient optimized wing-to-body fairing 202 of the present invention helps minimizes air separation, and therefore noise and drag, at the intersection where the trailing edge 206 meets the fuselage 101.

The inventors are unaware of any equivalent experiments and analysis conducted in the industry, or formal application of minimum curvature methods to surface design beyond that of CAD mesh blending, smoothing, and patching. As a result, airflow separation and resultant vortices were not observed or have been ignored by the industry with respect to low-wing commercial aircraft having the current wing root fairing 110 with its abrupt angled trailing edge portion 114 installed thereon. By contrast, the advantageous reduction of such airflow separation and vortices has been observed by replacing the current abrupt angled wing root trailing edge portion 114 on an airframe with a trailing edge wing-to-body fairing 202 of the present invention. Such reductions in airflow and vortices were observed during flight test experimentation using a Questair Venture aircraft and a Lancair Legacy aircraft. The resultant data contributed to determining appropriate formulae for performing gradient optimization of the WTB fairing 202. More specifically, through a combination of reiterative flight test experimentation, high performance computing (HPC) and CFD, the advantages of the trailing edge wing-to-body fairing 202 of the present invention using gradient optimization is clearly demonstrated.

Although an embodiment of the fairing 202 has been shown and described herein for mounting on the BOEING 737 model airframes (e.g., 737 NG-700 and the 737 MAX-7 airframes), such fairing and airframe are described for illustrative purposes only, as a person of ordinary skill in the art will appreciate that the method 800 and fairing 202 of the present invention can be provide for any other low-wing aircraft having a trailing edge wing root fairing 110.

It is well known that each aircraft wing 102 (left and right, symmetrical about the long axis of the aircraft) generates a separate downwash sheet. The challenge for a commercial aircraft (and most other aircraft) is that the left and right wings 102 are not connected. They each create a downwash sheet virtually independent of each other due to the lateral separation created by the fuselage 101. The unique effect of the WTB fairing 202 of the present invention is the more efficient joining of the left and right downwash sheets into one, more elliptical, wingtip to wingtip downwash sheet.

Prior art WTB fairings 111 cause a vortex to form at the wing trailing edge 114 to fuselage intersection. The left and right inboard wing vortexes disrupt the efficient joining of the left and right downwash sheets into the ideal elliptical overall downwash sheet. Even smoothing the WTB fairing does not reduce this inboard vortex enough to create this effect. Advantageously, the gradient optimized WTB fairing 202 is more efficient at reducing the inboard vortexes and creating the flow on the fuselage 101 that allows the left and right downwash sheets to join in a more elliptical manner.

Another advantage is that the present trailing edge wing-to-body fairing 202 can be implemented after the fuselage designs have been frozen or are already in production. For a newly designed aircraft, the fairing 202 can be iterative and be optimized with regard to the other components. A person of ordinary skill in the art will appreciate that other embodiments of the fairing assembly 202 can be formed and positioned in a similar manner described above for various aircraft models and at different locations on the fuselage.

While the foregoing is directed to embodiments of the present invention, other and further embodiments and advantages of the invention can be envisioned by those of ordinary skill in the art based on this description without departing from the basic scope of the invention, which is to be determined by the claims that follow.

What is claimed is:

1. A method of fabricating a wing-to-body fairing for reducing drag on an aircraft which has a fuselage, a wing, and a wing root fairing, the wing-to-body fairing being configured with forward and trailing edges, the forward edge of the wing-to-body fairing being configured for positioning at an aft portion of the wing root fairing and the trailing edge being configured for positioning at an aft portion of the fuselage, the method comprising the steps of:
selecting a first predetermined location on the aircraft corresponding to the aft portion of the wing root fairing;
selecting a second predetermined location on the aircraft corresponding to the aft portion of the fuselage;
determining a profile and angle of the forward edge of the wing-to-body fairing to conform to and match the aft portion of the wing root fairing at the first predetermined location;
determining a profile and angle of the trailing edge of the wing-to-body fairing to conform to and match the aft portion of the fuselage at the second predetermined location;
performing gradient optimization to minimize curvature over an exterior surface of the wing-to-body fairing based on the determined profile and angles at the forward and trailing edges of the wing-to-body fairing, wherein said gradient optimization includes providing a convex shaped profile at a forward portion of the wing-to-body fairing and a concave shaped profile at a rearward portion of the wing-to-body fairing; and
forming the wing-to-body fairing with an exterior surface having a smooth curvature as defined by the gradient optimization, wherein the trailing edge of the wing-to-body fairing is configured with matching angles and contours as the aft portion of the fuselage at the second predetermined location.

2. The method of claim 1, wherein the step of forming the wing-to-body fairing comprises configuring the forward edge of the wing-to-body fairing with matching angles and contours as the aft portion of the wing root fairing at the first predetermined location.

3. The method of claim 1, wherein the step of performing gradient optimization comprises selecting a plurality of control lines from the forward profile to the aft profile, and performing one-dimensional gradient optimization on each of the plurality of control lines.

4. The method of claim 3, wherein the step of selecting a plurality of control lines comprises determining a start point and an end point of each control line by subdividing the forward or aft edge profiles by uniform linear spacing.

5. The method of claim 3, wherein the step of selecting a plurality of control lines comprises determining a start point and an end point of each control line by subdividing the forward or aft edge profiles by uniform angular spacing.

6. The method of claim 3, wherein the step of selecting of the plurality of control lines comprises approximating airflow streamlines generated by at least one of computational fluid dynamics, wind tunnel testing, and flight testing.

7. The method of claim 5, further comprising iteratively repeating the approximation of airflow streamlines using streamline data from previous iterations to select the plurality of control lines.

8. The method of claim 3, where an analytical technique is used to functionally describe the optimal profile of each of the control lines.

9. The method of claim 3, wherein at least one of a numerical and graphical technique is used to select a number of control points along each control line, and minimizing local curvature according to the equation: [(dy₂/dx₂)−(dy₁/dx₂)]/[(dx₂+dx₁)/2] for each of the control points.

10. The method of claim 1, wherein the step of performing gradient optimization over an exterior surface of the wing-to-body fairing comprises performing a multi-dimensional gradient optimization with a weighed combination of longitudinal and circumferential curvatures.

11. The method of claim 9, wherein the step of determining the multi-dimensional optimization includes minimizing local curvature according to the equation:
$$k \frac{{\partial }^{2} y}{\partial {x}^{2}} + ( 1 - k ) \frac{{\partial }^{2} z}{\partial {x}^{2}} ,$$
where k is a numeric value in a range from 0 to 1.

12. The method of claim 1, wherein the steps of selecting the first and second predetermined locations on the aircraft include identifying first and second fuselage stations of the aircraft.

13. The method of claim 1, wherein said gradient optimization includes transitioning in a direction along a longitudinal axis of the of the wing-to-body fairing from the convex shaped profile at a forward portion of the wing-to-body fairing to the concave shaped profile at a rearward portion of the wing-to-body fairing.

14. The method of claim 1, wherein said gradient optimization includes transitioning in a direction along a longitudinal axis of the of the wing-to-body fairing from the concave shaped profile at a rearward portion of the wing-to-body fairing to the convex shaped profile at a forward portion of the wing-to-body fairing.

15. A wing-to-body fairing for reducing drag on an aircraft having a fuselage, a wing, and a wing root fairing, the wing-to-body fairing comprising:
a forward edge, a trailing edge, an upper edge and a lower edge, wherein the forward edge is configured for positioning adjacent a first predetermined location of an aft portion of the wing root fairing and the trailing edge is configured for positioning adjacent a second predetermined location of the aft portion of the fuselage, wherein a profile and angle of the forward edge of the wing-to-body fairing is configured to conform to and match the aft portion of the wing root fairing at the first predetermined location, and a profile and angle of the trailing edge of the wing-to-body fairing is configured to conform to and match the aft portion of the fuselage at the second predetermined location; and
wherein an exterior surface of the wing-to-body fairing is gradient optimized to minimize curvature over the exterior surface, said exterior surface having a generally convex shaped profile at a forward portion of the wing-to-body fairing and a generally concave shaped profile at a rearward portion of the wing-to-body fairing such that the trailing edge of the wing-to-body fairing is configured with matching angles and contours as the aft portion of the fuselage at the second predetermined location.

16. The wing-to-body fairing of claim 15, wherein said gradient optimization includes transitioning in a direction along a longitudinal axis of the of the wing-to-body fairing from a generally convex shaped profile at a forward portion of the wing-to-body fairing to a generally concave shaped profile at a rearward portion of the wing-to-body fairing.

17. The wing-to-body fairing of claim 15, wherein said gradient optimization includes transitioning in a direction along a longitudinal axis of the of the wing-to-body fairing from a generally concave shaped profile at a rearward portion of the wing-to-body fairing to a generally convex shaped profile at a forward portion of the wing-to-body fairing.

18. The wing-to-body fairing of claim 15, wherein the forward edge of the wing-to-body fairing is configured with matching angles and contours as the aft portion of the wing root fairing at the first predetermined location.

19. The wing-to-body fairing of claim 15, wherein the exterior surface of the wing-to-body fairing is gradient optimized by one-dimensional gradient optimization on each of a plurality of control lines.

20. The wing-to-body fairing of claim 19, wherein the plurality of control lines extend from the forward edge profile to the trailing edge profile and are subdivided by uniform linear spacing.

21. The wing-to-body fairing of claim 19, wherein the plurality of control lines extend from the forward edge profile to the trailing edge profile and are subdivided by uniform angular spacing.

22. The wing-to-body fairing of claim 19, wherein the plurality of control lines are defined by data received from at least one of computational fluid dynamics, wind tunnel testing, and flight testing.

23. The wing-to-body fairing of claim 19, wherein the exterior surface of the wing-to-body fairing is gradient optimized by at least one of a numerical and graphical technique to select a number of control points along each control line, and minimize local curvature according to the equation: [(dy₂/dx₂)−(dy₁/dx₂)]/[(dx₂+dx₁)/2] for each of the control points.

24. The wing-to-body fairing of claim 15, wherein the exterior surface of the wing-to-body fairing is gradient optimized by multi-dimensional gradient optimization with a weighed combination of longitudinal and circumferential curvatures.

25. The wing-to-body fairing of claim 24, wherein the multi-dimensional optimization includes minimizing local curvature according to the equation:
$$k \frac{{\partial }^{2} y}{\partial {x}^{2}} + ( 1 - k ) \frac{{\partial }^{2} z}{\partial {x}^{2}} ,$$
where k is a numeric value in a range from 0 to 1.

26. The wing-to-body fairing of claim 15, wherein the first and second predetermined locations are defined by fuselage stations of the aircraft.

27. The wing-to-body fairing of claim 15, wherein the aircraft includes a baggage/cargo door positioned at an aft side portion of the fuselage, the baggage/cargo door being openable outwardly, and wherein an aft portion of the wing-to-body fairing is formed on an exterior surface of the baggage/cargo door.

28. The wing-to-body fairing of claim 27 configured with a length that is in a range of 70% and 150% of a diameter of a cylindrical portion of the fuselage.

29. The wing-to-body fairing of claim 15, wherein the aircraft includes a baggage/cargo door positioned at an aft side portion of the fuselage, the baggage/cargo door being openable outwardly, and wherein the trailing edge of the wing-to-body fairing is formed longitudinally ahead of a leading edge of the baggage/cargo door.

30. The wing-to-body fairing of claim 29 configured with a length that is in a range of 70% and 150% of a diameter of a cylindrical portion of the fuselage.

31. The wing-to-body fairing of claim 13, wherein the aircraft includes a baggage/cargo door positioned at an aft side portion of the fuselage, the baggage/cargo door being openable inwardly, and wherein the trailing edge of the wing-to-body fairing is formed longitudinally ahead of a leading edge of the baggage/cargo door and without increasing an outer mold line of the baggage/cargo door.

32. The wing-to-body fairing of claim 31 configured with a length that is in a range of 70% and 150% of a diameter of a cylindrical portion of the fuselage.

33. The wing-to-body fairing of claim 15 which is configured for installation on one of a BOEING model 737 NG-700, 737 NG-800, and 737 NG-900 aircraft to reduce drag and noise by reducing airflow separation aft of a wing to fuselage junction.

34. The wing-to-body fairing of claim 15 which is configured for installation on one of a BOEING model 737 MAX-7, 737 MAX-8, 737 MAX-9, and 737 MAX-10 aircraft to reduce drag and noise by reducing airflow separation aft of a wing to fuselage junction.

35. A method of fabricating a wing-to-body fairing for reducing drag on an aircraft which has a fuselage, a wing, and a wing root fairing, the wing-to-body fairing being configured with forward and trailing edges, the forward edge of the wing-to-body fairing being configured for positioning at an aft portion of the wing root fairing and the trailing edge being configured for positioning at an aft portion of the fuselage, the method comprising the steps of:
selecting a first predetermined location on the aircraft corresponding to the aft portion of the wing root fairing;
selecting a second predetermined location on the aircraft corresponding to the aft portion of the fuselage;
determining a profile and angle of the forward edge of the wing-to-body fairing to conform to and match the aft portion of the wing root fairing at the first predetermined location;
determining a profile and angle of the trailing edge of the wing-to-body fairing to conform to and match the aft portion of the fuselage at the second predetermined location;
performing gradient optimization to minimize curvature over an exterior surface of the wing-to-body fairing based on the determined profile and angles at the forward and trailing edges of the wing-to-body fairing; and
forming the wing-to-body fairing with an exterior surface having a smooth curvature as defined by the gradient optimization, wherein the trailing edge of the wing-to-body fairing is configured with matching angles and contours as the aft portion of the fuselage at the second predetermined location.

36. The method of claim 35, wherein said gradient optimization includes transitioning in a direction along a longitudinal axis of the of the wing-to-body fairing from a convex shaped profile at a forward portion of the wing-to-body fairing to a concave shaped profile at a rearward portion of the wing-to-body fairing.

37. The method of claim 35, wherein said gradient optimization includes transitioning in a direction along a longitudinal axis of the of the wing-to-body fairing from a concave shaped profile at a rearward portion of the wing-to-body fairing to a convex shaped profile at a forward portion of the wing-to-body fairing.

38. A wing-to-body fairing for reducing drag on an aircraft having a fuselage, a wing, and a wing root fairing, the wing-to-body fairing comprising:
a forward edge, a trailing edge, an upper edge and a lower edge, wherein the forward edge is configured for positioning adjacent a first predetermined location of an aft portion of the wing root fairing and the trailing edge is configured for positioning adjacent a second predetermined location of the aft portion of the fuselage, wherein a profile and angle of the forward edge of the wing-to-body fairing is configured to conform to and match the aft portion of the wing root fairing at the first predetermined location, and a profile and angle of the trailing edge of the wing-to-body fairing is configured to conform to and match the aft portion of the fuselage at the second predetermined location; and
wherein an exterior surface of the wing-to-body fairing is gradient optimized to minimize curvature over the exterior surface, such that the trailing edge of the wing-to-body fairing is configured with matching angles and contours as the aft portion of the fuselage at the second predetermined location.

39. A wing-to-body fairing for reducing drag on an aircraft including a fuselage having a cylindrical pressure vessel, a wing, a wing root fairing and main landing gear, the wing-to-body fairing comprising:
a forward edge, a trailing edge, an upper edge and a lower edge, wherein the forward edge is configured for positioning adjacent a first predetermined location of an aft portion of the wing root fairing, the first predetermined location being determined by a cross section of the main landing gear, the trailing edge being configured for positioning adjacent a second predetermined location of the aft portion of the cylindrical pressure vessel, wherein a profile and angle of the forward edge of the wing-to-body fairing is configured to conform to and match the aft portion of the wing root fairing at the first predetermined location, and a profile and angle of the trailing edge of the wing-to-body fairing is configured to conform to and match the aft portion of the fuselage at the second predetermined location; and
wherein an exterior surface of the wing-to-body fairing is gradient optimized to minimize curvature over the exterior surface, such that the trailing edge of the wing-to-body fairing is configured with matching angles and contours as the aft portion of the fuselage at the second predetermined location.

40. The wing-to-body fairing of claim 1 wherein the forward edge is determined by a cross section of the aircraft faring located at the main landing gear and the trailing edge is determined by a cross section of the cylindrical portion of the pressure vessel.

41. The wing-to-body fairing of claim 20, wherein the multi-dimensional optimization includes minimizing local curvature according to the equation:
$$k \frac{{\partial }^{2} y}{\partial {x}^{2}} + ( 1 - k ) \frac{{\partial }^{2} z}{\partial {x}^{2}} ,$$
where k is a numeric value in a range from 0 to 1.

42. The wing-to-body fairing of claim 23 configured with a length that is in a range of 70% and 150% of a diameter of a cylindrical portion of the fuselage.
